(19) United States
(12) Patent Application Publication
(10) Pub. No.: US 2025/0276323 A1
(43) Pub. Date: Sep. 4, 2025

(54) MECHANOCHEMICAL BALL MILL REACTOR JAR WITH INTEGRATED FORCE MEASUREMENT

(71) Applicant: The Texas A&M University System, College Station, TX (US)

(72) Inventors: Jonathan R. Felts, College Station, TX (US); James D. Batteas, College Station, TX (US); Emmanuel Nwoye, Bryan, TX (US); Heily Chavez Davila, Los Angeles, CA (US)

(73) Assignee: The Texas A&M University System, College Station, TX (US)

(21) Appl. No.: 19/066,163

(22) Filed: Feb. 28, 2025

Related U.S. Application Data
(60) Provisional application No. 63/559,419, filed on Feb. 29, 2024.

(51) Int. Cl. B02C 17/18; B02C 17/14; G01L 5/00

(52) U.S. Cl. CPC B02C 17/1805; B02C 17/14; G01L 5/0052

(57) ABSTRACT

A mechanochemical ball mill includes a reaction cylinder comprising a first removable end, a ball freely disposed within the reaction cylinder, and a first sensor positioned proximal to the first removable end within the reaction cylinder such that impact forces from the ball during operation of the mechanochemical ball mill can be measured.

### CROSS-REFERENCE TO RELATED APPLICATIONS

This patent application claims priority from, and incorporates by reference the entire disclosure of, U.S. Provisional Application No. 63/559,419 filed on Feb. 29, 2024.

### STATEMENT REGARDING FEDERALLY SPONSORED RESEARCH

This invention was made with government support under Award Numbers 2023644 and 2303044 awarded by the National Science Foundation. The government has certain rights in the invention.

### TECHNICAL FIELD

The present disclosure relates generally to mechanochemical ball mill reactors and more particularly, but not by way of limitation, to a mechanochemical ball mill reactor jar with integrated force measurement.

### BACKGROUND

This section provides background information to facilitate a better understanding of the various aspects of the disclosure. It should be understood that the statements in this section of this document are to be read in this light, and not as admissions of prior art.

Efforts have been made to understand the mechanical environment of tools used in mechanochemical synthesis. The underlying mechanisms of these reactions begin with a firm grasp of how these tools facilitate mechanical activation and subsequent stress relaxations in reactive solids. Some examples of these tools include mortar and pestle, planetary and vibratory ball mills, twin screw extruders, and resonant acoustic mixers. Insights on how these tools affect reactivity have become increasingly important. Random ball motion within a mill using a transparent mill and stroboscope has been studied. These studies highlighted a technical challenge in measuring impact force or energy due to the numerous random collisions happening swiftly. Other studies introduced bifurcation in modeling approaches into local and global models. The local model focused on the thermal and mechanical effects during collisions, while the global model focused on device-specific considerations. Still other studies neglected powder particle fracture during the collision and considered impacts between two viscoelastic objects. Utilizing the Hertz model, the ball-powder-ball impact process was simulated and extended into numerical models across one to three dimensions for analyzing ball motion in detail. One study modified the Kelvin model to simulate the single head-on impact process, which showed better agreement with experimental data measuring the impact force over the impact duration. These models have been utilized to simulate impacts, each with different considerations and limitations. The Hertz impact model is suitable for simulating elastic impacts in low-energy modes. Later, the model considered severe plastic deformation of powder particles trapped between colliding balls, providing a more accurate representation.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In various aspects, a mechanochemical ball mill includes a reaction cylinder comprising a first removable end, a ball freely disposed within the reaction cylinder, and a first sensor positioned proximal to the first removable end within the reaction cylinder such that impact forces from the ball during operation of the mechanochemical ball mill can be measured.

In some aspects, the reaction cylinder comprises a second removable end. In some aspects, the mechanochemical ball mill includes a second sensor positioned proximal to the second removable end within the reaction cylinder such that forces from the ball during operation of the mechanochemical ball mill can be measured.

In some aspects, the first sensor is a force sensor. In some aspects, the force sensor is configured to measure forces between about 1-1,200 N and a time response of less than about 100 microseconds.

In some aspects, the mechanochemical ball mill includes a seal positioned between the first removable end and the reaction cylinder configured to ensure containment of reactants within the reaction cylinder.

In some aspects, the mechanochemical ball mill includes a plate that focuses impact pressure from the ball upon the first sensor.

In some aspects, the first removable end comprises a channel extending through the first removable end and configured to receive the first sensor.

In some aspects, the mechanochemical ball mill includes one or more instruments for measurement of UV-visible absorption, fluorescence, infra-red (IR), or Raman spectroscopy.

In some aspects, the mechanochemical ball mill is configured to interface with an X-ray diffractometer.

In various aspects, a method of measuring impact forces imparted by a ball of a mechanochemical ball mill includes loading a reaction cylinder with a powder and the ball, imparting vibratory motion to the reaction cylinder via a vibratory mill, and measuring impact forces of the ball upon a plate of the reaction cylinder that is configured to focus impact pressure from the ball on a sensor in contact with the plate.

In some aspects, the reaction cylinder comprises a first removable end. In some aspects, the mechanochemical ball mill includes a seal positioned between the first removable end and the reaction cylinder configured to ensure containment of reactants within the reaction cylinder. In some aspects, the first removable end comprises a channel extending through the first removable end and configured to receive the first sensor. In some aspects, the first removable end comprises a channel extending through the first removable end and configured to receive the first sensor.

In some aspects, the reaction cylinder comprises a second removable end and a second sensor positioned proximal to the second removable end within the reaction cylinder such that forces from the ball during operation of the mechanochemical ball mill can be measured.

In some aspects, the first sensor is a force sensor. In some aspects, the force sensor is configured to measure forces between about 1-1,200 N and a time response of less than about 100 microseconds.

In some aspects, the mechanochemical ball mill comprises one or more instruments for measurement of UV-visible absorption, fluorescence, infra-red (IR), or Raman spectroscopy.

In some aspects, the mechanochemical ball mill is configured to interface with an X-ray diffractometer.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a graph showing estimated impact force of a stainless-steel ball on different reaction vial materials, according to aspects of the disclosure;

FIG. 2A is an exploded assembly of an integrated reaction jar, according to aspects of the disclosure;

FIG. 2B is illustrates an assembled integrated reaction jar, according to aspects of the disclosure; and

FIG. 3 is a graph illustrating an impact force dispersion measured from a reactor jar with integrated force measurement and estimated impact force, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

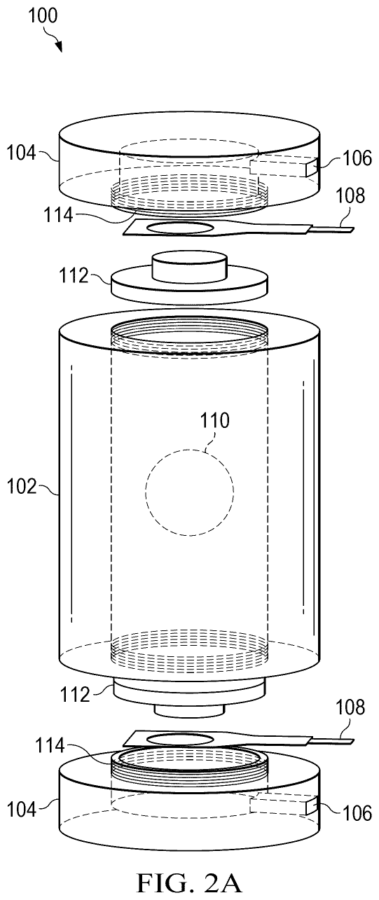

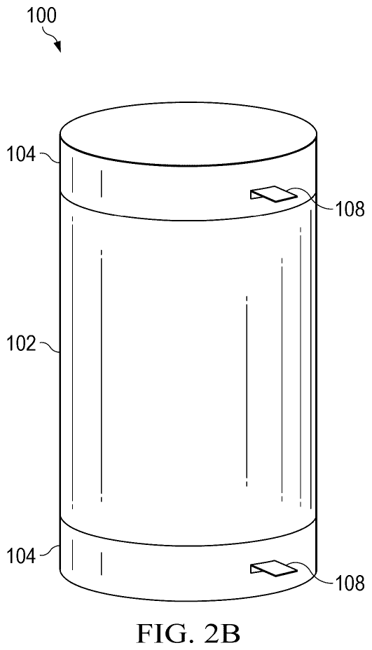

Compared to conventional mechanochemical reactors, the screw-top grinding jar discussed herein is the first mechanochemical reactor grinding jar that incorporates the ability to measure forces applied by the ball. Conventional mechanochemical reactors, such as ball mills, simply shake the reactants in the vessel at high power, with little or no knowledge of the forces exerted on the reactants. FIGS. 2A and 2B illustrate a screw-top grinding jar 100, according to aspects of the disclosure. FIG. 2A is an exploded assembly of jar 100, and FIG. 2B is perspective view of jar 100. Jar 100 includes a reaction cylinder 102 that includes a hollow interior space and a pair of covers 104 that are removably secured (e.g., via a threaded connection or the like) to ends of jar 100. In alternative aspects, jar 100 includes one cover 104, with an opposite end of reaction cylinder 102 being a closed end. Each cover 104 includes an opening 106 that is configured to receive a force sensor 108 (e.g., a FlexiForce® sensor) therethrough. The pair of force sensors 108 allow for quantitative force measurement during mechanochemical synthesis. In various aspects, force sensor 108 is configured to measure forces in the range of about 1-1,200 N and to have a response time of less than about 100 microseconds. The hollow of reaction cylinder 102 is configured to house a free-moving ball 110 that interacts with plates 112 that focus impact pressure from the ball onto force sensors 108. In various aspects, plates 112 may be metal and/or may have a plunger or cupped shape. Jar 100 enables real-time measurement of force applied via frequency variation during chemical reactions. In some aspects, Teflon seals 114 may be used to ensure containment of reactants in the grinding jar, making jar 100 a significant advancement in understanding and measuring the effects of quantifiable force in mechanochemical reactions.

### Theory of Force-Driven Chemistry in a Ball Mill

Consider a reciprocating ball mill that translates a distance L with a frequency of f. If it is further assumed that, on average, the ball within the mill has a speed of zero relative to the global frame of reference and a speed v=fL with respect to the reciprocating mill. The ball then impacts the vessel's side with an energy K=0.5 mv², where m is the ball's mass. Some fraction of the energy φ transfers from the ball to the vessel wall. Under the assumption of elastic collisions, the impact force can be related to the transfer of energy using Hertz contact mechanics between a sphere and a half space using Equation (1) below:

$$K = Fd \qquad Equation ( 1 )$$

Where F is the force, d is the indentation depth, E* is the effective elastic modulus, and R is the ball radius. The indentation depth d can also be written in terms of the applied force in Equation 2 below:

$$d = {( \frac{9}{19} )}^{1 / 3} {( \frac{{F}^{2}}{{E}^{* 2} R} )}^{1 / 3} \qquad Equation ( 2 )$$

Applying Equation (2) to Equation (1) and rearranging gives Equation (3) below:

$$F = {[ \frac{{KE}^{* 2 / 3} {R}^{1 / 3}}{{( \frac{9}{16} )}^{5 / 6}} ]}^{3 / 5} \qquad Equation ( 3 )$$

By expressing F in terms of mass, m, velocity, and material properties:

$$F = ( \frac{4}{3} ) {E}^{*} {{R}^{1 / 2} [ \frac{15 {mv}^{2}}{16 {E}^{*} {R}^{1 / 2}} ]}^{3 / 5} \qquad Equation ( 4 )$$

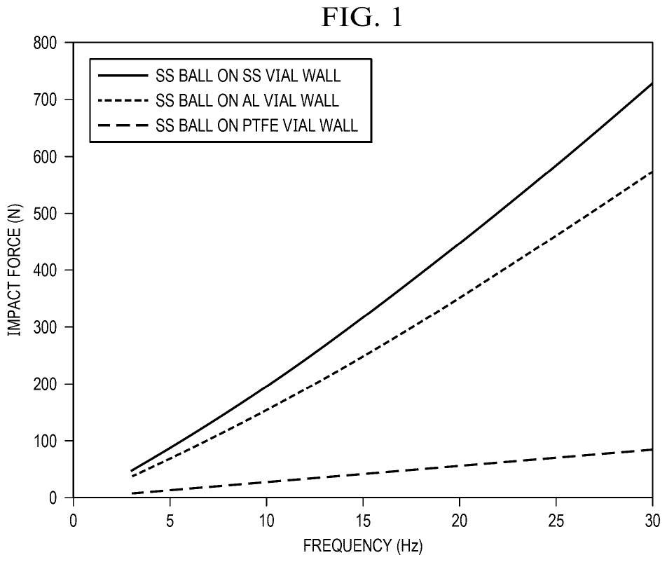

Equation (4) shows that the impact force is dependent on the impact velocity of the milling media and the impact velocity is simplified as shown above. FIG. 1 is a graph of the approximate impact force calculated using this model with different ball and vial materials.

Average pressure within the contact area is given by Equation (5) below:

$${P}_{av} = \frac{F}{π {a}^{2}} \qquad Equation ( 5 )$$

Where the contact radius, a is given by Equation (6) below:

$$a = {( \frac{3 FR}{4 {E}^{*}} )}^{1 / 3} \qquad Equation ( 6 )$$

Applying Equations (4) and (6) in Equation (5) and rearranging gives an average pressure within the contact:

$${P}_{av} = \frac{0.42 {m}^{1 / 5} {v}^{2 / 5} {E}^{* 4 / 5}}{{R}^{3 / 5}} \qquad Equation ( 7 )$$

Pressure is primarily a function of the stiffness of materials, density of the ball, and frequency of the oscillation. The Mixer Mill MM400 is one of the vibratory mills manufactured by Retsch as a solution for the preparation and analysis of solid samples in mechanochemistry and solid-state chemistry. This mill supports dry, wet, and cryogenic grinding of small volumes (for example, 2×20 mL, but volumes can be larger), efficiently mixing and homogenizing powders and suspensions at up to 30 Hz frequency. Its compact design makes it ideal for standard homogenization, as well as disrupting biological cells for DNA/RNA and protein extraction. The MM 400 can process for up to 99 hours, making it perfectly positioned to perform tedious mechanochemical synthesis.

In modeling impact dynamics of the ball in the vial, the linear vibratory motion of the vial center in the x-direction can be expressed by Equations (8)-(12) below. First, parameters of a cylindrical vial and ball such as radius, Rc, length, Lc, shaking frequency f, shaking distance Lp ball radius Rb, and density ρb, are defined. The cylindrical instantaneous velocity is given as:

$${V}_{instant} = {V}_{o} cos ( ft ( i ) ) \qquad Equation ( 8 )$$

$${V}_{o} = {L}_{p} \cdot f \qquad Equation ( 9 )$$

The ball dynamics are defined as:

Acceleration:

$${A}_{ccb} = [ 0 , - ρ \cdot \frac{4}{3} π {{R}_{b}}^{3} , - ρ \cdot \frac{4}{3} π {{R}_{b}}^{3} ] \qquad Equation ( 10 )$$

Velocity update:

$${V}_{elb} = {V}_{elb} + {A}_{ccb} \cdot dt \qquad Equation ( 11 )$$

Position update:

$${P}_{b} = {P}_{b} + {V}_{elb} \cdot dt \qquad Equation ( 12 )$$

Numerical simulation is performed to calculate the impact velocity distribution of the ball. A Matlab script iterates through timesteps and updates the cylindrical vial position based on the velocity and shaking frequency. The ball's velocity and position are updated based on the force due to gravity and the spinning ball effect is also adopted. The script calculates the collision point and angle between the ball and the cylinder vial and then reflects the ball's velocity based on the collision angle. The vial velocity is added to compute the total ball velocity. The process is repeated for the ball and endcap collisions and plotted to visualize the ball and vial motions.

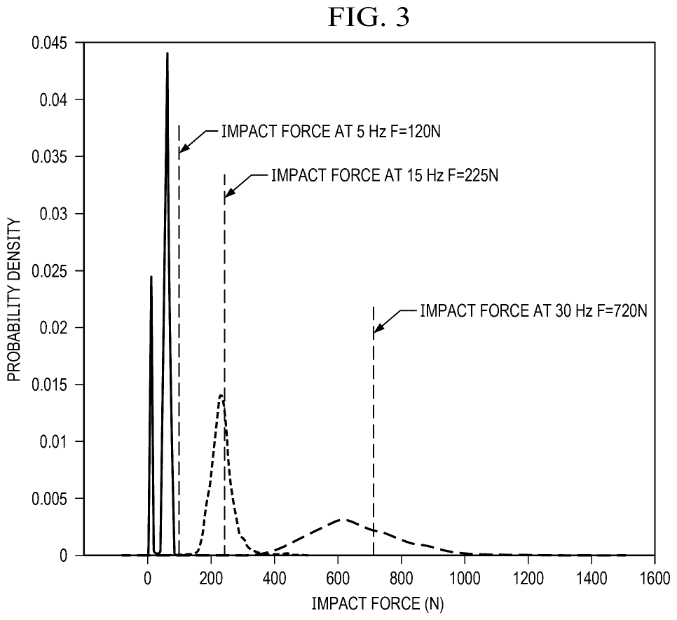

To validate this model, a reactor jar with an integrated force sensor equipped to capture the impact force and time at each impact was developed and is compatible for use in the Retsch MM400, an example of which is illustrated in FIGS. 2A-2B. The integrated reaction jar includes a force sensor, such as a FlexiForce® sensor, a sample stage, a free-moving ball, a reaction hollow cylinder, and a bottom cover. The force sensor is calibrated within an operating range to accurately capture the impact force ensemble. FlexiForce® sensors are useful in this application as they are able to accurately measure forces in which the impact time is minimal, such as those caused by the ball in a ball mill. This dispersion occurs as a result of constant motion between the reaction vial/cylinder and milling media. During operation of the integrated reaction jar, the ball freely moves within the jar in response to the movement of the jar. As the ball moves within the jar, the ball impacts the jar and the force sensor, which records the impact force. FIG. 3 shows the impact force dispersion for three frequency levels: minimum 5 Hz, median of 15 Hz, and maximum operating value of 30 Hz.

The estimated impact force is within the ensemble of impact forces measured at various operating frequencies. Next, a comparative study will be performed between a single-point force enabled using a Controlled Force Reactor and the impact force ensemble of the Retsch MM400 with integrated force measurement.

In some aspects, the integrated reaction jar may be combined with spectroscopy. For example, the integrated reactor jar may include instruments for measuring spectroscopy of chemical constituents. In various aspects, the instruments may be located near a bottom interior surface of the jar in order to facilitate accumulation of the chemical constituents around the instruments. Measurement of spectroscopy facilitates measurement of chemical composition during a chemical reaction including measurement of reaction intermediates. In various aspects, the instruments could include, for example, instruments for measurement of UV-visible absorption, fluorescence, infra-red (IR), or Raman spectroscopy. In situ structural details may also potentially be accomplished by interfacing with an X-ray diffractometer. #

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A mechanochemical ball mill comprising:
a reaction cylinder comprising a first removable end;
a ball freely disposed within the reaction cylinder; and
a first sensor positioned proximal to the first removable end within the reaction cylinder such that impact forces from the ball during operation of the mechanochemical ball mill can be measured.

2. The mechanochemical ball mill of claim 1, wherein the reaction cylinder comprises a second removable end.

3. The mechanochemical ball mill of claim 2, further comprising a second sensor positioned proximal to the second removable end within the reaction cylinder such that forces from the ball during operation of the mechanochemical ball mill can be measured.

4. The mechanochemical ball mill of claim 1, wherein the first sensor is a force sensor.

5. The mechanochemical ball mill of claim 4, wherein the force sensor is configured to measure forces between about 1-1,200 N and a time response of less than about 100 microseconds.

6. The mechanochemical ball mill of claim 1, further comprising a seal positioned between the first removable end and the reaction cylinder configured to ensure containment of reactants within the reaction cylinder.

7. The mechanochemical ball mill of claim 1, further comprising a plate that focuses impact pressure from the ball upon the first sensor.

8. The mechanochemical ball mill of claim 1, wherein the first removable end comprises a channel extending through the first removable end and configured to receive the first sensor.

9. The mechanochemical ball mill of claim 1, further comprising one or more instruments for measurement by UV-visible absorption, fluorescence, infra-red (IR), or Raman spectroscopy.

10. The mechanochemical ball mill of claim 1, wherein the mechanochemical ball mill is configured to interface with an X-ray diffractometer.

11. A method of measuring impact forces imparted by a ball of a mechanochemical ball mill, the method comprising:
loading a reaction cylinder with a powder and the ball;
imparting vibratory motion to the reaction cylinder via a vibratory mill; and
measuring impact forces of the ball upon a plate of the reaction cylinder that is configured to focus impact pressure from the ball on a sensor in contact with the plate.

12. The method of claim 11, wherein the reaction cylinder comprises a first removable end.

13. The method of claim 12, further comprising a seal positioned between the first removable end and the reaction cylinder configured to ensure containment of reactants within the reaction cylinder.

14. The method of claim 12, wherein the first removable end comprises a channel extending through the first removable end and configured to receive the first sensor.

15. The method of claim 12, wherein the first removable end comprises a channel extending through the first removable end and configured to receive the first sensor.

16. The method of claim 11, wherein the reaction cylinder comprises a second removable end and a second sensor positioned proximal to the second removable end within the reaction cylinder such that forces from the ball during operation of the mechanochemical ball mill can be measured.

17. The method of claim 11, wherein the first sensor is a force sensor.

18. The method of claim 17, wherein the force sensor is configured to measure forces between about 1-1,200 N and a time response of less than about 100 microseconds.

19. The method of claim 11, wherein the mechanochemical ball mill comprises one or more instruments for measurement by UV-visible absorption, fluorescence, infra-red (IR), or Raman spectroscopy.

20. The method of claim 11, wherein the mechanochemical ball mill is configured to interface with an X-ray diffractometer.
